(19) United States
(12) Patent Application Publication
(10) Pub. No.: US 2010/0242119 A1
(43) Pub. Date: Sep. 23, 2010

(54) ELECTRONIC DOCUMENT RIGHTS AND TRACKING SYSTEM

(76) Inventor: Kevin Flynn, Philadelphia, PA (US)

Correspondence Address: Kevin Flynn, 1420 Walnut St, Ste 917, Philadelphia, PA, 19102, US

(21) Appl. No.: 12/791,525

(22) Filed: Jun. 1, 2010

Related U.S. Application Data
(63) Continuation of application No. 12/378,606, filed on Feb. 17, 2009, now abandoned.

(51) Int. Cl. G06F 21/24; G06F 15/16

(52) U.S. Cl. 726/26; 709/217

(57) ABSTRACT

Method and system to identify document rights by use of the Internet or other networking system and then perform action(s) based on the rights identified in the document. A log may be created where predefined information will be populated and that log will be viewable by the document owner or other person who has access to the log.

### CONTINUATION APPLICATION

This application is a continuation of patent application Ser. No. 12/378,606 that was filed on Feb. 17, 2009. The original patent application was application Ser. No. 10/919,031 that was filed on Aug. 14, 2004.

### RELATED APPLICATIONS

This application claims priority under 35 USC sec. 119(e) to U.S. Provisional Application Ser. No. 60/495,041, filed Aug. 14, 2003, entitled “Electronic Document Tracking System.” This application also claims priority under 35 USC sec. 119(e) to U.S. Provisional Application Ser. No. 60/511,595, Filed Oct. 16, 2003, entitled “Electronic document tracking system.” This application also claims priority under 35 USC sec. 119(e) to U.S. application Ser. No. 10/919,031 Filed Aug. 14, 2004, entitled “Electronic Document Tracking System.” This application also claims priority under 35 USC sec. 119(e) to U.S. application Ser. No. 12/378,606 that was filed on Feb. 17, 2009, “Electronic Document Confidentiality Tracking System.”. The four (4) above-referenced applications are incorporated herein in their entirety by this reference.

### FIELD OF THE INVENTION

The present invention relates generally to electronic documents and a system and method to maintain their confidentiality.

### SUMMARY

Modern businesses use electronic documents and email to efficiently conduct business. The problem this that electronic documents are easily sent anywhere in the world and once sent, the owner cannot track where the document goes or to whom it is sent. The document(s) could contain trade secrets or proprietary data and be sent to a competitor. Or, electronic documents can be taken from a business, person, government entity or other without their knowledge and identifying the theft would be very difficult to discover. By using the Electronic Document Tracking System, an owner of an electronic document can have a good probability of knowing where the document is in the virtual world of computers, who is accessing it and when.

### DESCRIPTION

### Background of the Invention

Electronic documents can contain sensitive information including trade secrets, client lists, etc. This kind of information is imperative to the profitability and functioning of companies, governments, etc. To date, there is no way to automatically track when and where (a/k/a by whom) your documents were accessed. The Electronic Document Tracking System is a system that overcomes that void in modern technology.

While most word processors, and other programs, have a mechanism to password protect the document, and encryption software does exist, these implementations are cumbersome and sometimes require third-party software. The “electronic document tracking system” incorporates an encryption mechanism to provide a secure document and ensure that the document is tracked. Furthermore, the encryption mechanism will not require third-party software or passwords that are easily lost. Instead, the encryption mechanism will work off a list of IP addresses (or other hardware addresses that is computer specific) that are considered “secure” to the document owner.

### BRIEF DESCRIPTION OF THE DRAWINGS

FIG. 1 is an example computing environment.

FIG. 2 is an example networking environment.

### DETAILED DESCRIPTION OF THE INVENTION

### Accessing and Tracking

The method and system include embedding, in the electronic document, an electronic program, script or macro that encrypts the document and contacts the document owner's company, or a third party entity, upon accessing the electronic document.

Upon opening the electronic document, the embedded program, script or macro will contact the owner via electronic messaging. The contact may be via the Internet whereby the embedded program, script or macro containing a specific encrypted document tracking number (i.e. placement of a VBA script in Microsoft documents) can do an HTML call via a “get” statement to the owners web site where the “get” statement requests the IP address (or other unique address specific to the computer) of the machine on which the electronic document currently exists and the unencrypted unique document number (this would result in an error in the web servers web logs leaving behind the IP address of the computer accessing the document and the unique unencrypted document tracking number.). This method will provide a web log with the details of when and where the electronic document lies in cyberspace and who is accessing it.

Another method is to setup a server and assign it a specific port (socket server or SOAP server) that accepts data via the Internet. Once the program, script or macro verifies the IP address of the computer accessing the electronic document against the “approved IP address list,” the program will send a message to the sever including the IP address (or other hardware addresses that is computer specific) of the computer where the document is located in Cyberspace and the electronic document tracking number.

Once the encrypted electronic document has contacted the “server” the server will verify the data passed against its database and pass back a number that is associated with the document number to be utilized with the “one page encryption” software [as a matter of background, one page encryption was used by the Russians after WW2. While the One-Page encryption algorithm is noted here, any encryption algorithm may be used]. Once the electronic document has received the One Page encryption number, the document will self-decrypt and be accessible to the end-user. Utilization of this method will be transformative as it will change the file from an unusable file to a file that may be used and manipulated.

The point of incorporating encryption software with a tracking system is to ensure the tracking. That is, if a person simply opened the document on a machine that is not connected to the Internet, they could simple bypass the Internet Tracking Feature. By having the One-Page encryption number given by the server, the device has built-in a guarantee that the electronic document must contact the Tracking Server otherwise the document will not decrypt. The encryption also acts as additional layer of document security.

Another implementation of this methodology is for the company that develops the software to develop its own database that is accessible via the Internet. Then, the software company would contract, for a fee, with the clients and all of the documents would contact the software company's database and the software company would be responsible for tracking access to the documents and providing access information to the electronic document owner. The implementation of the software company's database would simply be a scalable version of the web site or unique port implementation used by the owner's of the electronic documents.

To embed the tracking program/script/macro, and the electronic document tracking number, into the electronic document the user would use a program that allows the user to navigate his or her computer to select the document they want protected. Once identified, the program would insert the embedded program/script/macro and unique encrypted document-tracking number into the electronic document; by doing this the document is transformed into a smart document. An example of such an implementation would be embedding a VBA script into Microsoft Documents. The program, script or macro could be configured to contact the owner's web site or the server (Socket or SOAP server) that the owner implemented at their entity (i.e. business, government, etc.).

Prior to the “navigating program” inserting the program/script/macro into the electronic document, the “navigation program” would create an entry in the owner's database that links the documents name and where it was to be used/sent, with a unique identifier number and a One-Page encryption number that is associated with the document or owner. Additionally, the document owner will be prompted for “activation” and “deactivations” dates. These dates are the dates when the document will begin to send data back to the owner or stop sending data back to the owner. After all, the electronic document might be time sensitive and the owner may not want the reporting, or access of the document, after one (1) year.

Another possible implementation of inserting the code into the document is by manipulating the “templates” used by the various software programs. Microsoft, WordPerfect and others use templates when starting new documents. By inserting the encryption and tracking code needed into these templates, the system has automated the process of inserting the code into the document.

This same methodology and apparatus may be used in conjunction with marketing. As electronic marketing grows, this system may be used to track how many people read a particular piece of electronic marketing literature. Based on the number of readers, the advertiser will know how effective the marketing campaign is. Also, royalties and other incentive marketing reimbursement mechanisms may be based on the “number of hits” produced by any one electronic marketing piece much like current reimbursement schemes for the Internet's “pay per click” web page referral agreements.

### Document Rights

If the implementation of the tracking system uses the socket or SOAP server method of tracking, the interaction with the document may be extended. Because the electronic document can pass a message over the Internet, it can either expect or not expect a reply message. Such an implementation may be used to approve or deny access to the document being viewed; or the document may be given privileges via the server (socket or SOAP server) to disallow printing of the document or other the document may be instructed to self-delete. While the document may not delete or copies, the implementation will cause a greater level of security for the document.

### Document Encryption

Programs like Microsoft Word and WordPerfect have password protection but passwords can be shared and there are programs that break password protection. To add an additional layer of protection and ensure tracking, The Electronic Document Tracking System will encrypt the electronic document. Upon accessing the document, the program, script or macro (i.e. a Microsoft Word VBA script) would check the IP addresses in the “allowed to access list” and compare them to the IP address (or other hardware addresses that is computer specific) of the computer accessing the document. If they match, the program, script or macro would contact the server (SOAP or socket server) for the One-Page encryption number and decrypt the document.

### IP Address Modual

The people with whom electronic documents are most commonly shared will know the end user's IP address (or other hardware addresses that is computer specific). In the event they do not, a small program, or a program executed from an Internet web page, is given to the end user. The purpose of this program is to determine the IP address of the computer that will be receiving the document. This ensures that the IP address being used in the embedded code is correct.

### Document Deletion Modual

A document will be set with a document deletion date. When the date occurs, the document will delete itself rendering it non-usable.

### Example Computing Environment

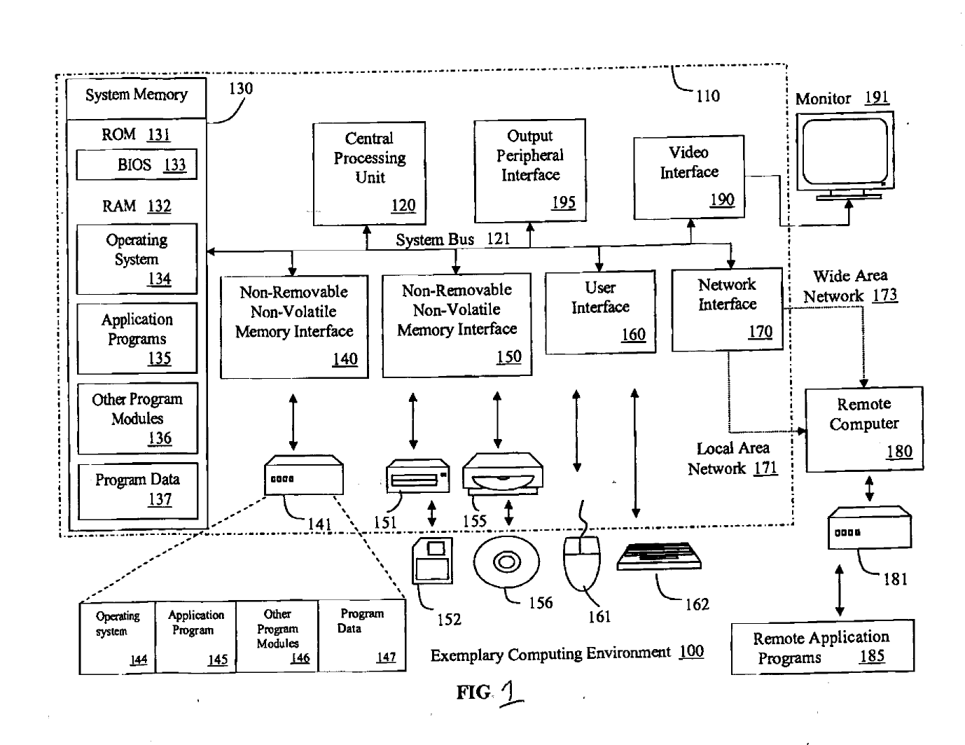

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or a combination of components illustrated in the exemplary operating environment 100.

With reference to FIG. 1, an example system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

The computer 110 typically includes a variety of computer readable media. Computer readable media can be any available media that can be accessed by the computer 110 and includes volatile and nonvolatile, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by the processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, the hard disk drive 141 is illustrated as storing operating system 144, application programs 145, other program modules 146, and program data 147. Note that these components can either be the same as or different from operating system 134, application programs 135, other program modules 136, and program data 137. Operating, system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers and a printer (not shown), which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes means for establishing communications over the WAN 173, such as the Internet. In a networked environment, program modules depicted relative to the computer 110, or portions thereof, may be stored in the remote memory storage device. By way of example, and not limitation, FIG. 1 illustrates remote application programs 185 as residing on a memory device 181. Remote application programs 185 include, but are not limited to web server applications such as Microsoft® Internet Information Services (IIS)® and Apache HTTP Server which provides content which resides on the remote storage device 181 or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

### Example Network Environment

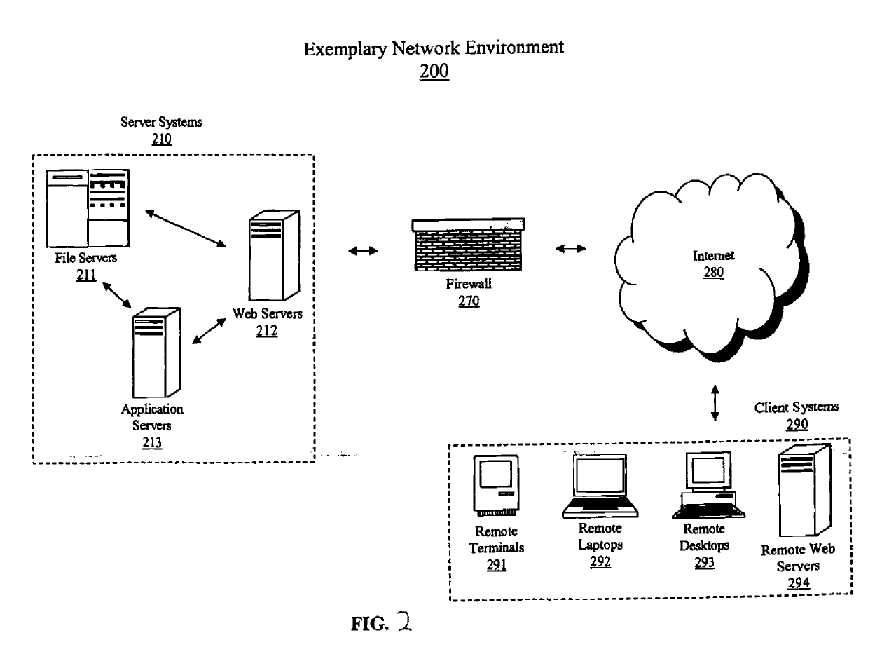

FIG. 2 illustrates an embodiment of a network environment in which an embodiment of the present invention can be implemented. The network environment 200 contains a number of server systems 210, which may include a number of file servers 211, web servers 212, and application servers 213. These servers are in communication with a wider area network such as the Internet 280 though typically some network security measures such as a firewall 270. A number of client systems 290 that are in communication with the server systems 210. The client computer systems can be a variety of remote terminals 291, remote laptops 292, remote desktops 293, and remote web servers 294. Service requests are sent by client systems 290 to the server systems 210 via the network 280. The server systems 210 process the service requests, and return the results to the client systems via the network 280.

FIG. 2 illustrates an exemplary network environment. Those of ordinary skill in the art will appreciate that the teachings of the present invention can be used with any number of network environments and network configurations.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is rather intended to include all changes and modifications that are within the scope and spirit of the invention.

1. A system and method that utilizes the Internet or networking system to obtain and verify document rights then performing actions based on said rights.

2. The method of claim 1, wherein a log is created at a predefined location in cyberspace and this log is populated with predefined information from the document.
